(19) United States
(12) Patent Application Publication
(10) Pub. No.: US 2015/0209709 A1
(43) Pub. Date: Jul. 30, 2015

(54) Filter Element

(71) Applicant: Carl Freudenberg KG, Weinheim (DE)

(72) Inventors: Alexandra Lazarevic, Birkenau (DE); Volker Braeunling, Heppenheim (DE); Robert Loesel, Heidelberg (DE)

(21) Appl. No.: 14/607,332

(22) Filed: Jan. 28, 2015

(30) Foreign Application Priority Data
Jan. 28, 2014 (DE) 10 2014 000 914.9

(51) Int. Cl. B01D 46/00; B01D 46/52

(52) U.S. Cl. CPC B01D 46/0027; B01D 46/521; B01D 46/002

(57) ABSTRACT

In respect of the object of specifying a filter element which can be used as an inertial separator and, while being of compact construction, can be used in small installation spaces, said filter element displaying a low level of flow resistance, the highest possible dust-holding capacity and the best possible separating-off action, a filter element which is configured in the form of an inertial separator, that is to say has means which separate off particles by deflection of a flow medium, is characterized in that the means comprise, or have, nonwoven fabric.

### CROSS-REFERENCE TO RELATED APPLICATION

This application claims priority to German Patent Application No. DE 10 2014 000 914.9, filed on Jan. 28, 2014, the disclosure of which is incorporated herein by reference in its entirety.

### FIELD OF THE INVENTION

The invention relates to a filter element, and more particularly to an inertial separator having pleated wall pairs, wherein at least a portion of the pleated wall pairs is formed from a non-woven fabric.

### BACKGROUND OF THE INVENTION

EP 1 262 223 A1 discloses a paint-mist separator. Such inertial separators are used to separate off, in particular, coarse particles. The prior art also discloses concepts for separating off liquid aerosols. The already known inertial separators, however, do not allow a compact construction, which renders the same suitable for use in small installation spaces.

Against this background, there is a need for inertial separators which can be used in relatively small installation spaces. Relatively small installation spaces are found, in particular, in motor vehicles.

The inertial separators known from the prior art, moreover, often display a high level of flow resistance, a poor separating-off action and a low dust-holding capacity.

### SUMMARY OF THE INVENTION

It is therefore an object of the invention to specify a filter element which can be used as an inertial separator and, while being of compact construction, can be used in small installation spaces, said filter element displaying a low level of flow resistance, the highest possible dust-holding capacity and the best possible separating-off action.

The present invention achieves the aforementioned object by way of the features of claim 1.

First of all, it has been found that straightforward inertial separators do not provide any additional filter action. Following on from this, it has been found according to the invention that a filter element which consists of nonwoven fabric may be configured in the form of an inertial separator. The invention therefore realizes a combination of two separating-off mechanisms, that is to say inertial separation and filtration, in one filter element. This makes it possible to realize long service lives. It is also possible to avoid design concepts based on a two-stage design. The aforementioned concepts would require a large amount of installation space. This disadvantage can be overcome according to the invention by use being made of just one filter element. This allows an entire filter system to have a small and compact construction. By virtue of the two aforementioned separating-off mechanisms being combined and interlinked, it is possible to make use of filter media with high levels of air permeability, this making it possible to achieve low pressure losses. Combining an inertial separator and the nonwoven-fabric filter medium according to the invention unites two filter stages in one. It is usually the case that coarse dust is filtered by way of a pre-filter element or a filter mat. It is only in the second filter stage that fine dust is held back. It is often the case that a pre-filter element requires a shorter interval between changeovers than the second filter stage. This renders a high level of maintenance outlay necessary. The filter element according to the invention, however, makes it possible to generate a pressure loss which is very low in comparison with two filter stages. Furthermore, the filter element can be installed in a small installation space. The filter element can be used over a relatively long period of time and thus has a long service life, since the dust-holding capacity thereof is considerably increased and separated-off dust does not result in the porosity of the filter medium being reduced. To this extent, the invention specifies a filter element which can be used as an inertial separator and, while being of compact construction, can be used in small installation spaces, said filter element displaying a low level of flow resistance, the highest possible dust-holding capacity, and best possible separating-off action.

This means that the object mentioned in the introduction has been solved.

The means could be configured in the form of pleated walls which are produced from nonwoven fabric or have nonwoven fabric. The filter element has said means in order to force deflection of a flow medium. This means that inertial effects result in coarse particles being separated off, said particles being bound in the nonwoven fabric and on the surface thereof. It is advantageously the case that depth filtration causes particles to be bound in the nonwoven fabric and surface filtration causes particles to be bound to the surface of the nonwoven fabric. At the same time, some air can flow through the nonwoven fabric, as a result of which fine particles are also efficiently held back.

The filter element could have a plurality of V-shaped or gabled-roof-arrangement pleated-wall pairs, wherein in each case two pleated-wall pairs are spaced apart opposite one another, and are offset in relation to one another, such that at least one flow channel is formed between said pleated-wall pairs. A flow medium can thus flow around the open edges of the pleated-wall pairs and is deflected into flow channels in the process.

The pleated-wall pairs could define in each case two planes, wherein the planes are spaced apart from one another and there is likewise spacing between the pleated-wall pairs in the planes. It is thus possible for a flow medium to be deflected in a particularly effective manner. This open construction means that blocking of the filter element cannot take place. It has surprisingly been found that, despite bypass channels being generated as a result of flow, the quality of particle separation is not adversely affected. This is attributable to the combination of inertial separation by deflection of coarse particles and simultaneous depth filtration by way of the nonwoven-fabric filter medium.

The filter element could have two flat filters. Two commercially easily attainable flat filters can be used to create, following straightforward installation, a basic body in which a multiplicity of flow channels are provided.

The pleat tips of the flat filters could be located one upon the other, and therefore, in each case four pleated walls form a flow channel. This creates a closed-off flow channel which can have a flow medium flowing through it axially.

Two through-passages could be formed in at least one flow channel, wherein a first through-passage is designed in the form of an entry opening into the flow channel and a second through-passage is designed in the form of an exit opening from the flow channel. This allows a flow medium to be guided through the filter element in order to bring about inertial separation of particles entrained in the flow medium.

The through-passages are arranged relative to one another such that the flow direction of a flow medium is deflected through 90° as the medium exits from the flow channel. This gives rise to inertial separation.

### BRIEF DESCRIPTION OF THE DRAWINGS

In the drawings:

FIG. 1 shows a schematic perspective view of a first exemplary embodiment of a filter element in which V-shaped or gabled-roof-arrangement pleated walls are located opposite one another, but are offset in relation to one another, and

FIG. 2 shows a schematic perspective view of two pleated flat filters located opposite one another, the pleat tips thereof being located one upon the other and thus forming flow channels in which through-passages are formed on opposite sides.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

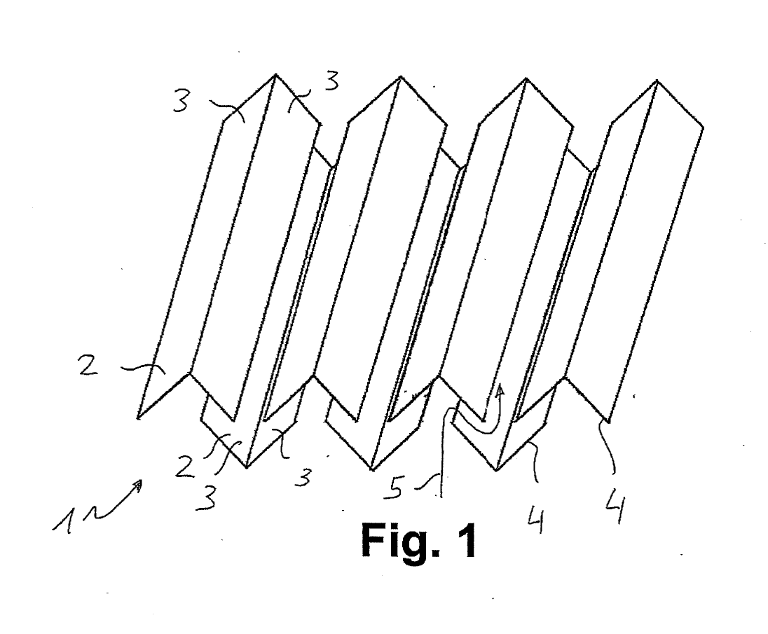

FIG. 1 shows a filter element 1 which is configured in the form of an inertial separator, that is to say has means 2 which separate off particles by deflection of a flow medium. The means 2 have nonwoven fabric.

The means 2 are configured in the form of pleated walls 3 which are produced from nonwoven fabric or have nonwoven fabric.

The filter element 1 has a plurality of V-shaped or gabled-roof-arrangement pleated-wall pairs 4, wherein in each case two pleated-wall pairs 4 are spaced apart opposite one another and are offset in relation to one another such that at least one flow channel 5 is formed between said pleated-wall pairs.

The flow channel 5 is illustrated schematically by an arrow.

The pleated-wall pairs 4 define in each case two planes, wherein the planes are spaced apart from one another and there is likewise spacing between the pleated-wall pairs 4 in the planes.

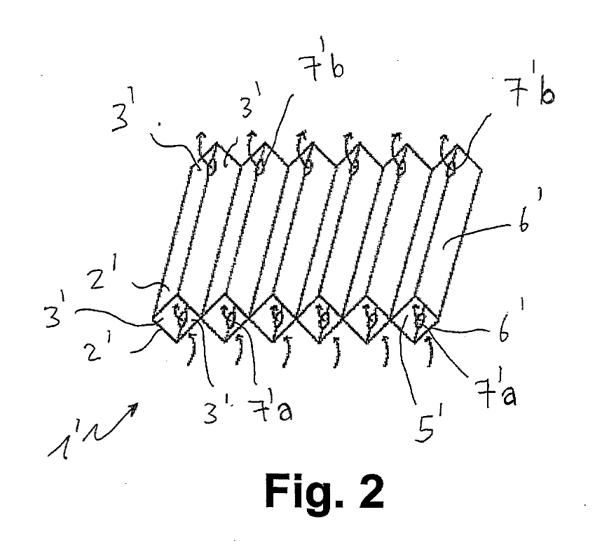

FIG. 2 shows a filter element 1′ which is configured in the form of an inertial separator, that is to say has means 2′ which separate off particles by deflection of the flow medium. The means 2′ have nonwoven fabric.

The means 2′ are configured in the form of pleated walls 3′ which are produced from nonwoven fabric or have nonwoven fabric. The filter element 1′ has two flat filters 6′.

The pleat tips of the flat filter 6′ are located one upon the other, and therefore in each case four pleated walls 3′ form a flow channel 5′.

Two through-passages 7′a, 7′b are formed in at least one flow channel 5′, wherein a first through-passage 7′a is designed in the form of an entry opening into the flow channel 5′ and a second through-passage 7′b is designed in the form of an exit opening from the flow channel 5′.

The through-passages 7′a, 7′b are arranged relative to one another such that the flow direction of a flow medium is deflected through 90° as the medium exits from the flow channel 5′.

While certain representative embodiments and details have been shown for purposes of illustrating the invention, it will be apparent to those skilled in the art that various changes may be made without departing from the scope of the disclosure, which is further described in the following appended claims.

What is claimed is:

1. A filter element configured as an inertial separator, the filter element comprising:
a plurality of substantially V-shaped pleated wall pairs, wherein at least a portion of each of the pleated wall pairs is formed from a non-woven fabric.

2. The filter element according to claim 1, wherein each of the pleated wall pairs includes a first wall and a second wall oriented transverse to each other and abutting each other along a common edge.

3. The filter element according to claim 2, wherein the first wall is oriented perpendicular to the second wall.

4. The filter element according to claim 1, wherein each of the pleated wall pairs includes an interior corner formed at an intersection of a first wall thereof and a second wall thereof.

5. The filter element according to claim 4, wherein the interior corner of at least one of the pleated wall pairs is arranged opposite the interior corner of at least one adjacent pleated wall pair.

6. The filter element according to claim 4, wherein the interior corner of at least one of the pleated wall pairs is in facing relationship with the interior corner of at least one adjacent pleated wall pair.

7. The filter element according to claim 6, wherein the at least one of the pleated wall pairs is offset laterally relative to the at least one adjacent pleated wall pair to form at least one flow channel therebetween.

8. The filter element according to claim 1, wherein a first pleated wall pair includes a first wall oriented along a first plane and a second wall oriented along a second plane and a second pleated wall pair includes a third wall oriented along a third plane and a fourth wall oriented along a fourth plane, wherein the first plane is oriented parallel to the third plane and the second plane is oriented parallel to the fourth plane.

9. The filter element according to claim 8, wherein the first wall is spaced apart from the third wall and the second wall is spaced apart from the fourth wall.

10. The filter element according to claim 9, wherein an edge of the first wall abuts an edge of the fourth wall and an edge of the second wall abuts an edge of the third wall, wherein the first wall, the second wall, the third wall, and the fourth wall cooperate to form a flow channel therebetween.

11. The filter element according to claim 1, wherein at least one of the pleated wall pairs cooperates with an adjacent one of the pleated wall pairs to form a flow channel therebetween.

12. The filter element according to claim 11, wherein the cooperating pleated wall pairs include a first throughpassage and a second throughpassage fluidly coupling the flow channel to an exterior of the cooperating pleated wall pairs.

13. The filter element according to claim 12, wherein the first throughpassage is formed adjacent a first end of the flow channel and the second throughpassage is formed adjacent a second end of the flow channel

14. The filter element according to claim 12, wherein the flow channel has a quadrilateral cross-sectional shape including four corners, wherein the first throughpassage is formed at a first corner of the flow channel and the second throughpassage is formed at a second corner of the flow channel

15. The filter element according to claim 14, wherein the first corner is formed opposite the second corner.

16. A filter element configured as an inertial separator, the filter element comprising:
a first pleated wall pair comprising a first wall and a second wall abutting each other along a common edge, wherein the first wall is oriented along a first plane and the second wall is oriented along a second plane, the first plane oriented transverse to the second plane, at least a portion of the first pleated wall pair formed from a non-woven fabric; and
a second pleated wall pair comprising a third wall and a fourth wall abutting each other along a common edge, wherein the third wall is oriented along a third plane and the fourth wall is oriented along a fourth plane, the third plane oriented transverse to the fourth plane, at least a portion of the second pleated wall pair formed from a non-woven fabric;
wherein the first wall is oriented parallel to the third wall and spaced apart therefrom and the second wall is oriented parallel to the fourth wall and spaced apart therefrom.

17. The filter element according to claim 16, wherein the first pleated wall pair and the second pleated wall pair are spaced apart opposite one another and are offset relative to one another to form a flow channel therebetween.

18. The filter element according to claim 17, wherein an interior corner of the first pleated wall pair formed between the first wall and the second wall points in a direction opposite of an interior corner of the second pleated wall pair formed between the third wall and the fourth wall.

19. The filter element according to claim 16, wherein the first pleated wall pair abuts the second pleated wall pair to form a flow channel therebetween having a quadrilateral cross-sectional shape.

20. The filter element according to claim 19, wherein the first pleated wall pair includes a first throughpassage formed along the common edge of the first wall and the second wall and the second pleated wall pair includes a second throughpassage formed along the common edge of the third wall and the fourth wall, the first throughpassage formed adjacent a first end of the flow channel and the second throughpassage formed adjacent a second end of the flow channel.
